(19) United States
(12) Patent Application Publication
(10) Pub. No.: US 2024/0411000 A1
(43) Pub. Date: Dec. 12, 2024

(54) ADAPTIVE ASSEMBLY OF LIDAR FOR ASYMMETRIC ILLUMINATION

(71) Applicant: GM Cruise Holdings LLC, San Francisco, CA (US)

(72) Inventors: Hui Li, San Jose, CA (US); Samuel Celaya, Oakland, CA (US)

(21) Appl. No.: 18/333,378

(22) Filed: Jun. 12, 2023

(51) Int. Cl. G01S 7/497; G01S 7/481; G01S 17/89; G01S 17/931

(52) U.S. Cl. CPC G01S 7/497; G01S 7/4817; G01S 17/89; G01S 17/931

(57) ABSTRACT

Aspects of the disclosed technology provide systems and methods for testing and adaptively aligning a Light Detection And Ranging (LiDAR) unit. The test apparatus includes a frame configured to accept the LiDAR unit, a movable screen having at least two positions, and an imaging device configured to observe the screen in the at least two positions and capture images of the area illuminated by the LiDAR unit at each position. An offset between the images captured at the two positions is determined. The offset is used to calculate the actual pointing direction of the LiDAR unit being tested. Characteristics of the area illuminated by the LiDAR unit are measured and analyzed to independently adjust the LiDAR unit in several degrees of freedom.

### BACKGROUND

### 1. Technical Field

The present disclosure generally relates to assembly and testing of a Light Detection And Ranging (LiDAR) light source for use on an autonomous vehicle (AV).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions conventionally performed by human drivers, such as detection of objects proximate to the AV in order to provide safe and efficient transportation. One means of detecting objects involves the use of a LiDAR system that uses asymmetric illumination.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example AV environment, according to some aspects of the disclosed technology.

FIG. 2 illustrates an example LiDAR unit, according to some aspects of the disclosed technology.

FIG. 3 illustrates an example transmission lens, according to some aspects of the disclosed technology.

FIG. 4 illustrates an example adaptive assembly (AA) test apparatus, according to some aspects of the disclosed technology.

FIG. 5A depicts an example block diagram of an AA test system, according to some aspects of the disclosed technology.

FIGS. 5B-6B depict details of the AA test apparatus, according to some aspects of the disclosed technology.

FIGS. 7-9 describe an example process of calculating the actual pointing direction of a LiDAR unit 110, according to some aspects of the disclosed technology.

FIGS. 10-14 describe an example process of calculating the spatial frequency response (SFR) of a region of interest (ROI), according to some aspects of the disclosed technology.

FIG. 15 is an example flowchart of the operation of the AA test system, according to some aspects of the disclosed technology.

FIGS. 16-18 are example flowcharts of subprocesses of the flowchart of FIG. 15, according to some aspects of the disclosed technology.

### DETAILED DESCRIPTION

The detailed description set forth herein is intended as a description of various example configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. It will be clear and apparent that the subject technology is not limited to the specific details set forth herein and may be practiced without these details. In some instances, structures and components are shown in block diagram form in order to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

AV sensing systems utilize information about the surrounding environment in order to detect and avoid objects/entities enabling the vehicle to navigate through the environment. One sensor used to detect objects is a LiDAR sensor, which typically emits multiple pulses of laser light, referred to herein as an illumination beam, and detects reflections of the pulses from objects. By measuring the direction of the emitted beam and the time interval between emitting the beam and receiving the reflection, the system determines the position of the sensed object surface in 3D space relative to the LiDAR sensor.

It is important to verify that the illumination beam is emitted in the intended direction and has the proper optical characteristics. In certain embodiments, the illumination beam is designed to provide asymmetric illumination, i.e., the beam has a profile shape other than an axially symmetric circle and/or the intensity of the emitted illumination beam is not uniform over the entire profile. There are multiple assembly details that affect the direction and characteristics of the illumination beam, including variability of the optical elements and mechanical assemblies. Conventional assembly methods are passive manual processes based on the tolerance stack and may require several time-consuming iterations to obtain a properly functioning system.

The systems and methods disclosed herein address the challenges of conventional assembly by defining means of assessing the actual pointing direction of the LiDAR illumination beam as well as the shape and other characteristics of the beam. Feedback control of an automated adjustment system precisely adjusts the position of the transmission optical elements to meet the performance requirements. This description includes the test equipment structure as well as the methods of analyzing the measurements obtained using the test equipment.

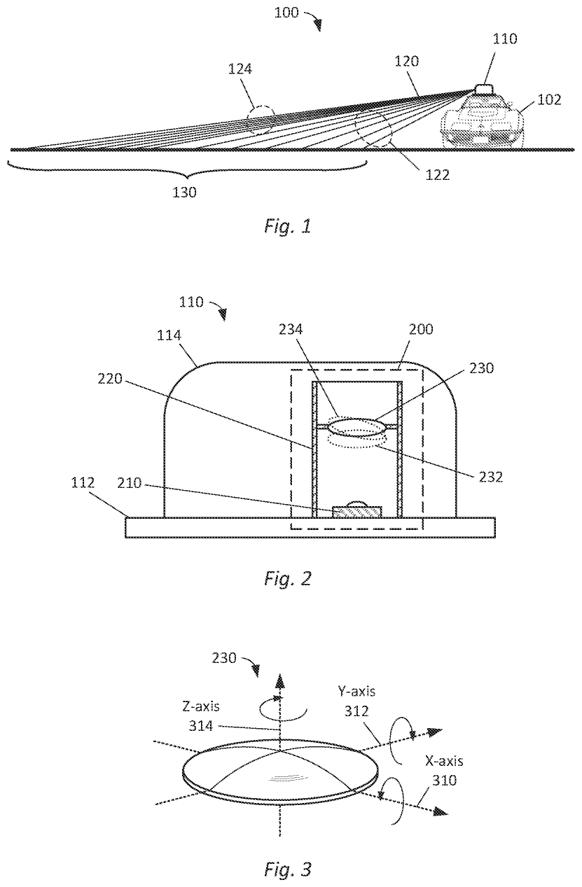

FIG. 1 illustrates an example AV environment 100, according to certain aspects of the disclosed technology. A LiDAR system 110 is disposed on a vehicle 102 (e.g., an AV) and configured to illuminate a field of view (FOV) 130. In certain embodiments, the LiDAR system 110 has a sparse illumination and/or detector configuration. In certain embodiments, the LiDAR illumination is a near-field flash system. In certain embodiments, the LiDAR system 110 is positioned near a roofline of vehicle 102 and pointed down towards the ground, as shown in FIG. 1, to detect objects in proximity to the vehicle 102. In certain embodiments, the beam 120 comprises a first portion 122 that has a first intensity, e.g., an intensity suitable for detecting objects within a first distance from the LiDAR unit 110, and a second portion 124 that has a second intensity that is greater than the first intensity, e.g., an intensity suitable for detecting objects within a region that is beyond the first distance. In certain embodiments, the FOV 130 has a shape, e.g., an area defined by a minimum threshold intensity of light emitted by the LiDAR unit 110, that comprises one or more geometric shapes, e.g., a regular or irregular polygon, a rectangle, a trapezoid, and ellipse, furthermore the illumination area may comprise any geometric attribute, e.g., a straight side, a curved side, an acute or obtuse angle, and a plurality of sides.

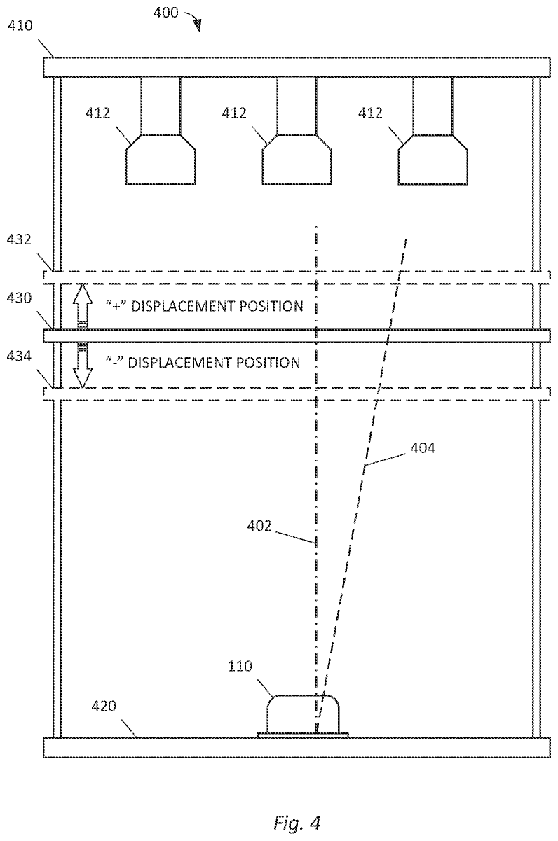

FIG. 2 illustrates an example LiDAR unit 110, according to certain aspects of the disclosed technology. The unit 110 comprises a base 112 with a shell 114. A transmission assembly 200 is disposed within the shell 114. In certain embodiments, a receiver assembly (not shown in FIG. 2) is also disposed within the shell 114. In certain embodiments, the base 112 comprises one or more datum features (not visible in FIG. 2) that enable the unit 110 to be precisely positioned with respect to an external system, e.g., the vehicle 102 or a test fixture. The transmission assembly 200 comprises a light source 210, a transmission lens 230, and a mechanical structure to house the optical component 220.

In certain embodiments, the lens 230 comprises one or more optical elements that may be transmissive or reflective, may comprise one or more materials, e.g., multiple types of glass and coatings, and may shape or modify the light provided by the light source 210. In certain embodiments, the lens 230 comprises a mask or equivalent beam-limiting element. In certain embodiments, the lens 230 comprises an aspheric lens or a free-form lens in a non-spherical shape. In this example, the lens 230 is a single transmissive lens but the principles discussed are applicable to all embodiments.

In certain embodiments, the lens 230 is fixedly coupled to the structure 220 at the completion of manufacturing of the LiDAR unit 110 but lens 230 is movable with respect to structure 220 during portions of the assembly and testing. In certain embodiments, the lens 230 redirects light emitted by light source 210 to emerge from the top or any side of the LiDAR unit 110, although in this example the illumination beam emerges from the top of the shell 114. In certain embodiments, lens 230 is positioned and oriented so as to form the illumination beam emitted by the unit 110 to a desired size and shape of FOV 130.

The mounting of lens 230 to structure 220 allows adjustment of the relative position and orientation of lens 230 with respect to the structure 220. For example, the position of lens 230 in FIG. 2 can be considered a nominal position and the position 232 shows lens 230 moved vertically (in this illustration) with respect to this nominal position. Similarly, position 234 shows lens 230 tilted with respect to the nominal position. In this disclosure, unless explicitly stated otherwise, the label 230 refers to the lens either generically or at the nominal position while labels 232, 234 refer to the same lens when displaced to the positions 232, 234 or to the positions themselves.

In certain embodiments, the light source 210 is a vertical-cavity surface-emitting laser (VCSEL) or a functionally equivalent laser device that emits light within a desired frequency range and of a desired range of intensity. In this disclosure, unless explicitly stated otherwise, the term “light” refers to electromagnetic energy having a wavelength in the range of approximately 100-1000 nm, including visible, infrared, and ultraviolet light. In certain embodiments, the light source 210 emits light having a dispersion pattern. In certain embodiments, the light source 210 emits collimated light. In certain embodiments, the light source 210 comprises multiple light-emitting devices (not shown in FIG. 2) of identical or different construction and that emit light at common or different frequencies and/or with common or different intensities. In certain embodiments, the transmission assembly 200 comprises multiple sets of lenses 230 and structures 220.

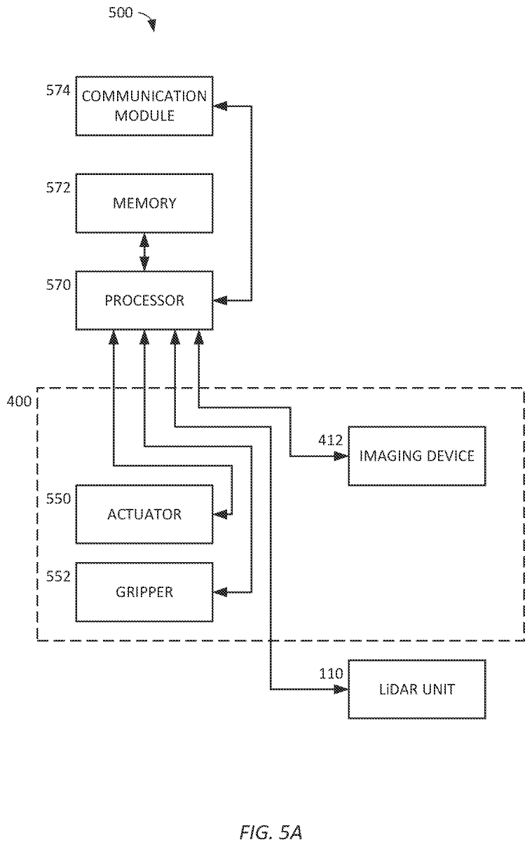

FIG. 3 illustrates an example transmission lens 230, according to certain aspects of the disclosed technology. In this example, lens 230 is a single plano-convex transmissive optical element with an X-axis 310 and a Y-axis 312 lying in a plane parallel to the planar surface of the lens 230 with a Z-axis 314 perpendicular to the axes 310, 312. In this disclosure, unless stated otherwise, changes of the mounting of the lens 230 with respect to the structure 220 are discussed with respect to the six degrees-of-freedom (DOF) associated with axes 310, 312, 314.

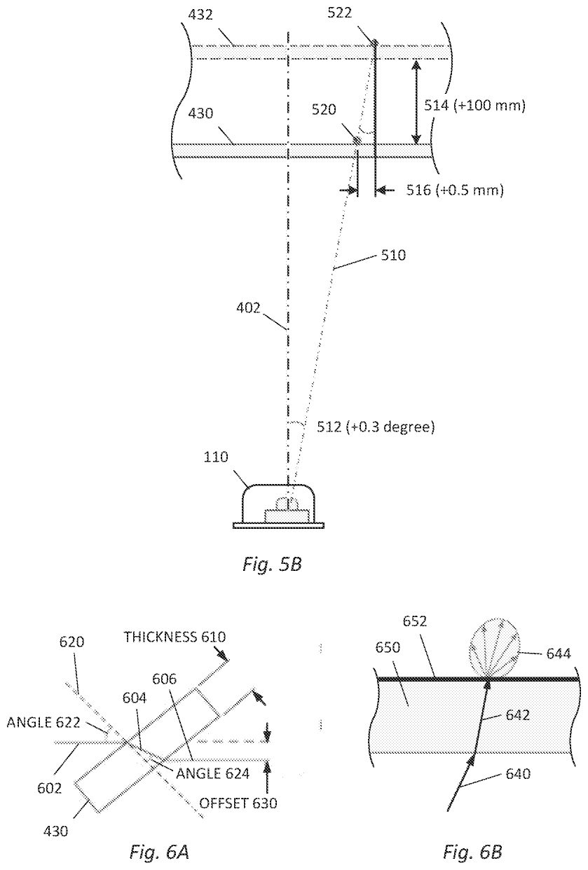

FIG. 4 illustrates an example adaptive assembly (AA) test apparatus 400, according to certain aspects of the disclosed technology. The test apparatus comprises a top frame 410 fixedly coupled to a bottom frame 420. A screen 430, shown in a nominal position in FIG. 4, is movably coupled to the bottom frame 420, e.g., slides along rails disposed between the top frame 410 and the bottom frame 420. The bottom frame 420 is configured to accept a LiDAR unit 110 in a position and orientation that are precisely determined, e.g., by contacting of datum surfaces (not shown in FIG. 4) of the LiDAR unit 110 with corresponding datum surfaces (not shown in FIG. 4) of bottom frame 420. The distance from the bottom frame 420 to the current position of screen 430 is measured, e.g., by one or more laser measurement devices (not shown in FIG. 4) at corners of the frames 410, 420, that enables a determination of the distance of the screen 430 from the axes 310, 312, 314 of the LiDAR unit 110. The LiDAR unit 110 has an expected pointing direction 402, e.g., a direction defined with respect to the datum surfaces of the LiDAR unit 110 and therefore known with respect to the test apparatus 400. The LiDAR unit 110 also has an actual pointing direction 404, e.g., due to manufacturing tolerances and material variations.

The screen 430 is capable of being displaced from position 430 to at least one position, e.g., position 432, which is defined in this example as a positive displacement. In certain embodiments, the screen 430 can be displaced to a second position 434, which is defined in this example as a negative displacement. In certain embodiments, the positions 430, 432, 434 are disposed along the expected pointing direction 402. In this disclosure, unless explicitly stated otherwise, the label 430 refers to either the screen either generically or at the nominal position while labels 432, 434 refer to either the same screen when displaced to the positions 432, 434 or to the positions themselves. In certain embodiments, the screens at positions 430, 432, 434 are different screens that are selectively moved into the respective positions. In certain embodiments, the test apparatus 400 comprises an actuator (not visible in FIG. 4) coupled between the bottom frame 420 and the screen 430 and configured to move the screen between at least two of the positions 430, 432, 434.

The test apparatus comprises an imaging device 412, e.g., an imaging camera that includes a telecentric lens. The imaging device 412 is configured to observe a portion of the screen 430 in at least two of positions 430, 432, 434. In certain embodiments, there are multiple imaging devices 412 that cover respective portions of screen 430. In certain embodiments, one or more of the imaging devices 412 have a capability to selectively adjust their magnification, e.g., to observe a first region of screen 430, in one or more of the positions 430, 432, 434, at a first resolution and observe a second region of screen 430 that is smaller than the first region at a second resolution that is greater than the first resolution. In certain embodiments, the position of the imaging devices 412 are fixed relative to the bottom frame 420. In certain embodiments, the imaging devices 412 are movable relative to the bottom frame 420 with a position sensor (not shown in FIG. 4) to measure and report the position of the imaging devices 412 with respect to the bottom frame 420 so that the position of the imaging devices 412 can be determined with respect to the screen 430.

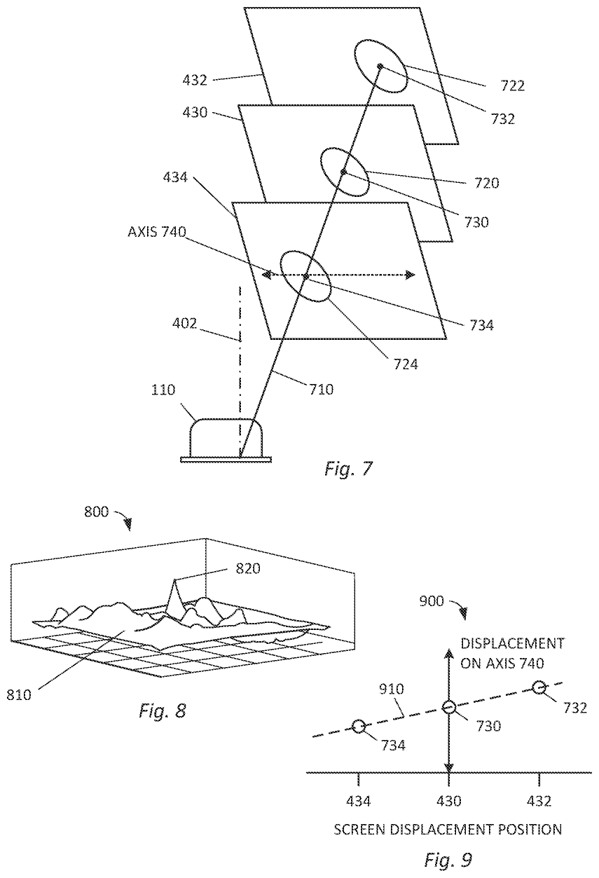

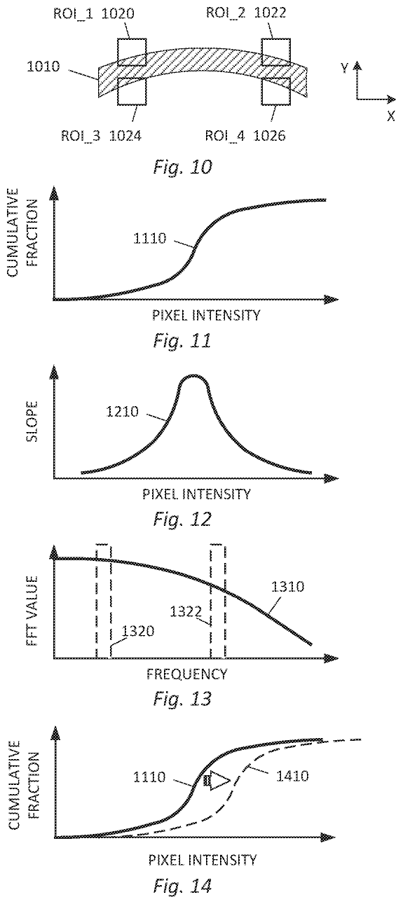

FIG. 5A depicts an example block diagram 500 of an AA test system, according to some aspects of the disclosed technology. The test apparatus 400 includes an imaging device 412, as shown in FIG. 4. Structure elements, e.g., the bottom frame 420, have been omitted for clarity. Arrows indicate a communicative couple of components. In certain embodiments, a gripper 552 is coupled to the bottom frame 420 and configured to adjust at least one of a position and an orientation of the transmission lens 230 with respect to the base 420. In certain embodiments, the gripper is a multi-axis robotic arm as is known to those of skill in the art. In certain embodiments, a portion of the gripper is configured to detachably couple to an internal feature of the LiDAR unit, e.g., the base 112 or the structure 220, and is configured to be locked in position prior to the LiDAR unit 110 and be removed from the test apparatus 400 with the LiDAR unit 110 so as to enable a subsequent bonding process that permanently fixes the position and orientation of lens 230 in the structure 220. In certain embodiments, the gripper is removed from the LiDAR unit 110 after the lens 230 is fixedly coupled to the structure 220.

In certain embodiments, a processor 570 is communicatively coupled to one or more of the imaging device 412, the actuator 550, and the gripper 552 of the test apparatus 400. In certain embodiments, processor 570 is a general-purpose processor or a service, e.g., a “cloud” emulation of a processor and operating system. In certain embodiments, processor 570 is a special-purpose processor wherein instructions are incorporated into the actual processor design. Processor 570 may be a completely self-contained computing system, may contain multiple cores or processors, a bus, a memory controller, a cache, etc. The processor 570 is configured to be communicatively coupled to a LiDAR unit 110 while installed in the test apparatus 400. In certain embodiments, the processor is also communicatively coupled to a communication module 574 that is configured to communicate with external systems, e.g., a server or a database or a supervisory computer, as known to those of skill in the art.

In certain embodiments, the system 500 comprises a non-volatile, machine-readable medium 572, which is interchangeably referred to as a “memory” herein, that is communicatively coupled to the processor 572. The memory 572 contains instructions that, when loaded into the processor 570 and executed, cause the processor 570 to execute certain operational steps. In certain embodiments, the memory 572 is any non-transitory computer-readable data storage device, e.g., a hard disk, a solid-state drive (SSD), a floppy disk, a compact disk (CD), a flash memory, a Secure Digital (SD) card, a microSD card, a magnetic tape, a read-only memory (ROM), or a combination thereof. In certain embodiments, the memory 572 is embedded in the hardware of processor 570. In certain embodiments, the memory 572 is remote from the processor 570.

In certain embodiments, one or more of the processor 570, the memory 572, and the communication module 574 are physically remote from the test apparatus 400 or each other, e.g., running on a server (not shown in FIG. 5A). In certain embodiments, the remote server is commutatively coupled to the components of the test apparatus 400 via a wired or wireless means, e.g., Ethernet or an Institute of Electrical and Electronic Engineers (IEEE) 802.11 protocol.

FIG. 5B depicts details of the AA test apparatus 400, according to certain aspects of the disclosed technology. In this example, the screen 430 is perpendicular to the expected pointing direction 402 in positions 430 and 432. In this example, the actual pointing direction 510 of the illumination beam is at an angle 512, e.g., 0.3 degree, to the expected pointing direction 402. A ray of the illumination beam at this angle arrives at a “front” surface of screen 430 and creates a spot 520 on a “back” surface of screen 430. When the screen is displaced to position 432, e.g., by distance 514, e.g., 100 mm, from position 430, the same ray creates a spot 522 of the back side of the screen 432. Due to the angle of the actual pointing direction 510 from the expected pointing direction 402, spot 522 on screen 432 is displaced by distance 516 from the spot 520 on screen 430. In this example, spot 522 is displaced 0.5 mm from spot 520. While presented in the example of FIG. 5 in two dimensions, e.g., X and Z, extension of the principles to three dimensions will be obvious to those of skill in the art. The angle of the actual pointing direction 510 relative to the expected pointing direction 402 can be calculated from the screen displacement 514 and the spot displacement 516 using known methods of trigonometry.

It should be noted that the size of the illumination area on a screen inherently varies with the distance of the screen from the LiDAR unit 110. The offset 516 therefore includes a magnification of the illuminated area due to the larger distance of screen 432 from the LiDAR unit 110, compared to the distance of screen 430 from the LiDAR unit 110.

FIG. 6A depicts a detail of the AA test apparatus 400, according to certain aspects of the disclosed technology. A light ray 602 strikes a first surface of a screen 430, which has parallel flat surfaces and a uniform thickness 610, at angle 622 with respect to a reference line 620 that is perpendicular to the surface of screen 430. The ray 602 is deflected to an angle 624 and ray 604 travels through the thickness 610 to reach the second surface of screen 430, where the ray 604 is deflected to ray 606 that is parallel to the original angle of ray 602. Ray 606 is offset from ray 602 by offset 630 in a plane perpendicular to rays 602, 606. This offset must be included in the calculation of the angle 512.

FIG. 6B depicts another detail of the AA test apparatus 400, according to certain aspects of the disclosed technology. As discussed with respect to FIG. 6A, incoming ray 640 is deflected at the first surface of screen 650 to ray 642. In this example, however, screen 650 comprises a translucent layer 652 on the back surface. The ray 642 is dispersed in pattern 644 by the translucent layer 652. Identification of the location of the point of dispersion of pattern 644 comprises focusing an image of the translucent layer 652 onto the imaging sensor of imaging device 412.

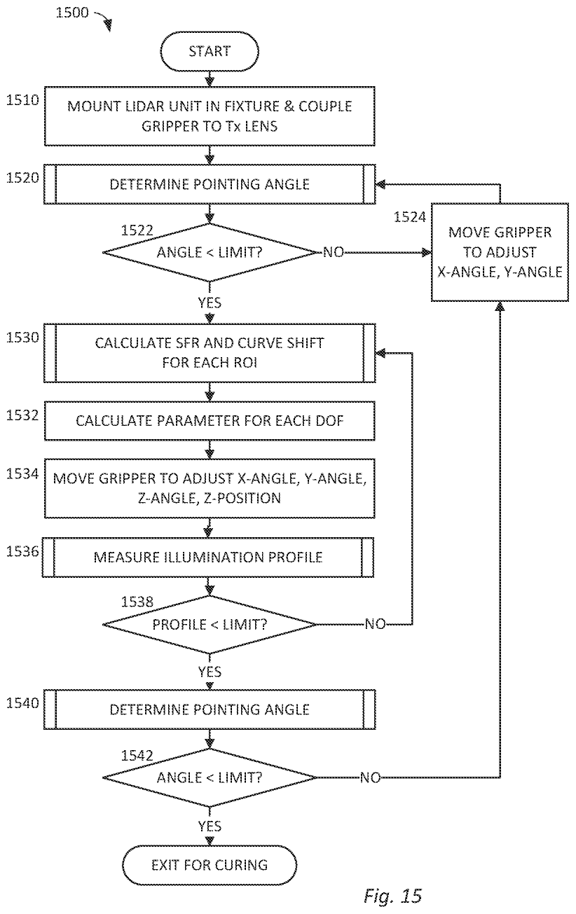

FIGS. 7-9 describe an example process of calculating the actual pointing direction of a LiDAR unit 110, according to certain aspects of the disclosed technology. In FIG. 7, the LiDAR unit 110 emits an illumination beam along axis 710 that creates an illuminated area 720 having a reference point 730 on screen 430 when the screen is disposed at the nominal position. The screen is displaced to position 434, whereupon the illumination area 724 has a reference point 734. Similarly, the screen is then displaced to position 432 whereupon the illumination area 722 has a reference point 732. In this example, reference points 730, 732, 734 are displaced from each other along lateral axis 740.

FIG. 8 illustrates a further example of the operation of the AA test system 400, according to certain aspects of the disclosed technology. The 3D plot 800 displays correlation value of the observed image of the illumination area on a displaced screen, e.g., the image of illumination area 724, when 2D cross-correlated with the observed image of the illumination area 720 on screen 430 in the nominal position. The surface 810 represents the correlation value when the image of illumination area 724 is incrementally displaced from the illumination area 720. The peak correlation value 820 will be seen when the image of illumination area 724 (at the displaced screen position 434) is offset from the image of illumination area 720 (at the nominal screen position 430) such that the two images are aligned, as is known to those of skill in the art. In certain embodiments, the image of the illumination area projected onto the displaced screen position, e.g., the illumination area 724, must be scaled down to compensate for the magnification of the image projected onto the other screen position, e.g., the illumination area 720, induced by the distance between the screen positions 432 and 430, as discussed with respect to FIG. 5. In certain embodiments, the size of the image of the further screen position must also be scaled to compensate for the deflection of the illumination beam caused by the thickness of the screen 430, as discussed with respect to FIGS. 6A-6B, the images of the illumination images will need to be scaled to compensate for the effect of the thickness of the screen 430. The position of the maximum correlation value will be associated with the angle between the actual pointing direction 710 and the expected pointing direction 402.

FIG. 9 is a plot 900 of the offsets determined by the 2D cross-correlation, according to certain aspects of the disclosed technology. The displacement of the illumination areas between the nominal screen position 430 and one of the positive and negative screen positions 432, 434, e.g., distance 514 of FIG. 5, are plotted on the x-axis of plot 900. The lateral offset calculated from the positions of the maximum correlation values are plotted against their respective screen positions as points 730, 732, 734. A curve 910 is fitted to the plotted points 730, 732, 734. The angle of the actual pointing direction, e.g., the angle between line 402 and line 710 of FIG. 7, can be calculated from the slope of line 910 using known principles. In certain embodiments, curve 910 is a straight line.

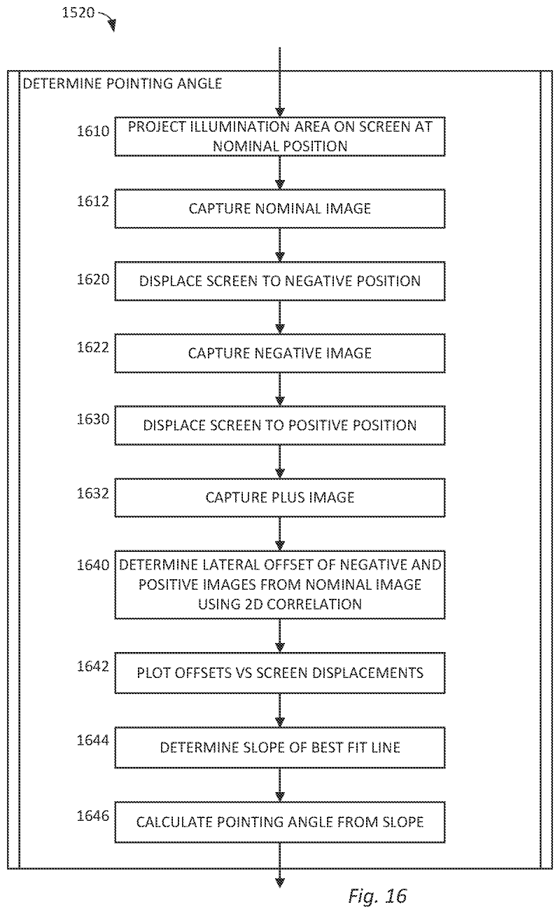

FIGS. 10-14 describe an example process of calculating the SFR of a ROI, according to certain aspects of the disclosed technology. FIG. 10 illustrates an example method of analyzing data from the AA test system 400. In this example, the projected illumination area 1010 formed on a screen has an asymmetric shape having X and Y axes as shown. ROIs have been selected in four locations, 1020, 1022, 1024, 1026 that are also referred to herein as “ROI_1,” “ROI_2,” ROI_3”, “ROI_4.” Images of the entire illumination area 1010 and of each of the ROIs 1020, 1022, 1024, 1026 are provided by the imaging devices 412 of FIG. 4. Each of the images are divided into pixels. In certain embodiments, the images of the ROIs have a greater resolution than the image of the entire illumination area 1010. In certain embodiments, one or more of the ROIs are selected to include an edge of illumination area 1010.

FIG. 11 depicts a cumulative curve 1110, according to certain aspects of the disclosed technology. The intensity of each pixel of the received image of a particular ROI is determined, then the number of pixels having an intensity less than or equal to a threshold is counted. The threshold is incrementally increased until the count reaches the total number of pixels of the image, as known to those of skill in the art.

FIG. 12 depicts a slope curve 1210, according to certain aspects of the disclosed technology. A derivative of multiple points along curve 1110 are calculated to determine the slope of curve 1110 at each point along curve 1110 and the values of the derivative are plotted as curve 1210, as known to those of skill in the art.

FIG. 13 depicts a fast Fourier transform (FFT) curve 1310, according to certain aspects of the disclosed technology. A FFT is performed on curve 1210 and plotted as curve 1310 as known to those of skill in the art. One or more frequency windows 1320, 1322 are selected. In certain embodiments, the number and frequency of the windows 1320, 1322 is separately chosen for each ROI. For example, window 1320 may be chosen for ROI_1 and ROI_3 of FIG. 10 while window 1322 may be chosen for ROI_2 and ROI_4. In certain embodiments, there is a single window 1320 for an ROI and the FFT value of that window is the SFR value for that ROI. In certain embodiments, there are multiple windows for a single ROI and the FFT values of the multiple windows are averaged to produce a single SFR value for that ROI.

FIG. 14 illustrates a further example method of analyzing data from the AA test system 400, according to certain aspects of the disclosed technology. The cumulative curves 1110 of each ROI captured at each of the screen positions 430, 432, 434 are compared. The shift between curves of the same ROI at two different screen positions, e.g., the curve 1110 derived from screen position 432 compared to the curve 1110 derived from screen position 430, is determined. In certain embodiments, the shift of a curve 1110 for an ROI between a first pair of screen positions, e.g., between screen positions 432 and 430 and between screen positions 434 and 430, are averaged to produce a single shift value for that ROI.

There are four degrees of freedom (DOF) that can be separately evaluated using the SFRs and shift values of ROIs 1-4.

For angular orientation around the x-axis 310 of lens 230:
1) calculate a first difference between the SFR values of ROI_1 and ROI_3
2) calculate a second difference between the SFR values of ROI_2 and ROI_4
3) determine, based in part on the first and second differences, an adjustment to be made in the angular orientation of the lens 230 around the x-axis 310

In an illustrative example, the portion of ROI_1 within area 1010 has a higher intensity than the portion of ROI_3 within area 1010. The cumulative curve 1110 for ROI_1 will rise faster (steeper in the center region) and the slope curve 1210 for ROI_1 will have a higher peak. This will result in a general increase in the FFT curve 1310 for ROI_1 and the SFR value for ROI_1 will be higher than the SFR value for ROI_3. The same sequence of effects is true for ROI_2 vs ROI_4. In certain embodiments, the x-axis orientation adjustment is based on an average of the first and second differences and, in general, the adjustment is proportional to the average value of the differences.

For angular orientation around the y-axis 312 of lens 230:
1) calculate a third difference between the SFR values of ROI_1 and ROI_2
2) calculate a fourth difference between the SFR values of ROI_3 and ROI_4
3) determine, based in part on the third and fourth differences, an adjustment to be made in the angular orientation of the lens 230 around the y-axis 320

The methodology for adjusting the y-axis orientation is the same as described for the x-axis orientation with the comparison of difference ROIs. In certain embodiments, the y-axis orientation adjustment is based on an average of the first and second differences and, in general, the adjustment is proportional to the average value of the differences.

For angular orientation around the z-axis 314 of lens 230:
1) calculate a first difference between the SFR values of ROI_1 and ROI_3
2) calculate a second difference between the SFR values of ROI_2 and ROI_4
1) calculate a fifth difference between the first and second differences
2) determine, based in part on the fifth difference, an adjustment to be made in the angular orientation of the lens 230

In certain embodiments, the first and second differences of the z-axis evaluation are the values calculated during the x-axis evaluation. In certain embodiments, the first and second differences are re-evaluated after the x-axis adjustment is performed. In certain embodiments, the calculation of the first and second differences are replaced by calculations of the third and fourth differences and the fifth difference is the difference between the third and fourth differences. In certain embodiments, the calculation of the fifth difference is an average of a sixth difference between the first and second differences and a seventh difference between the third and fourth differences. In certain embodiments, the z-axis orientation adjustment is based on the fifth difference and, in general, the adjustment is proportional to the value of the fifth difference.

A properly configured and positioned transmission lens 230, whether a single lens or a multi-element optical assembly, will produce a collimated illumination beam. A collimated beam will produce the same area 1010 on the screen at each position. A lack of collimation will result in one or more of a reduction in the total intensity within area 1010, a change in the size or shape of area 1010, and a blurred edge of the area 1010. For translational position along the z-axis 314 of lens 230:
1) measure the cumulative curve of ROI_1 at two different screen positions
2) determine the maximum value of the cumulative curves of ROI_1 at the two different screen positions
3) determine the maximum of the slope curve of the cumulative curve of ROI_1 at the two different screen positions
4) calculate a first difference between the maximum values of the cumulative curves at the two difference screen positions
5) calculate a second difference between the maximum slope values of ROI_1 at the two different screen positions
6) calculate the shift in the cumulative curve of ROI_1 between the two screen positions
7) determine, based in part on one or more of the first difference, the second difference, and the shift, an adjustment to be made in the translational position along the z-axis 314 of lens 230.

In certain embodiments, the determination of the adjustment is based solely on the first difference. In certain embodiments, the determination of the adjustment is based solely on the second difference. In certain embodiments, the determination of the adjustment is based solely on the shift.

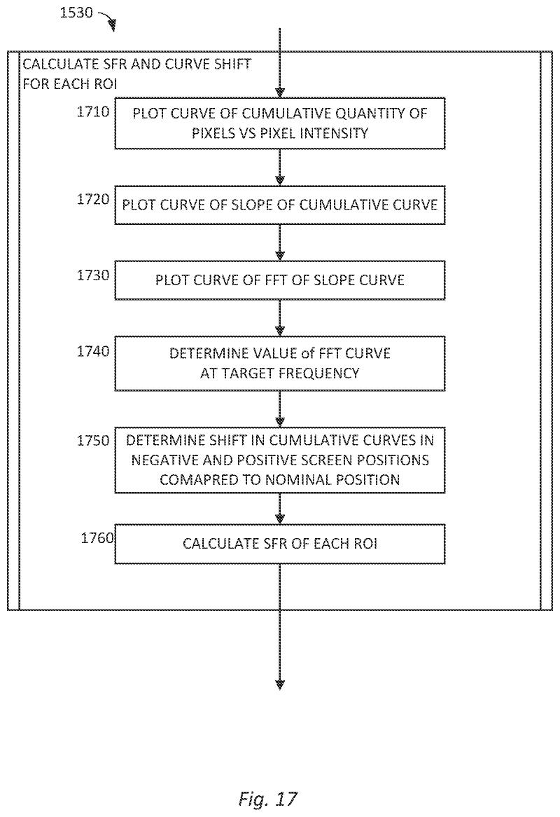

FIG. 15 is an example flowchart 1500 of the operation of the AA test system, according to certain aspects of the disclosed technology. The process begins with step 1510 wherein a partially assembled LiDAR unit 110 is mounted to the bottom frame of test apparatus 400. A gripper is attached to the transmission lens 230. The gripper and the LiDAR unit 110, specifically the light source 210, are communicatively coupled to the processor 570. In step 1520, the test apparatus is operated, e.g., as described with reference to FIG. 7, to capture multiple images of the illumination area projected by the LiDAR unit 110 on the screen 430 in multiple positions, e.g., positions 430, 432, 435. The images are analyzed as described with respect to FIG. 7-9 to determine the actual pointing direction. In step 1522, the deviation of actual pointing direction from the expected pointing direction is compared to a predetermined pointing limit. If the determined deviation is less than the pointing limit, the process proceeds to step 1530. Otherwise, the process branches to step 1524, wherein the processor calculates an adjustment and commands the gripper to reposition the lens 230 and then return to step 1520.

In step 1530, the processor obtains images of at least two ROIs and analyzes the images as described with respect to FIG. 10-13 to determine the SFR of each ROI. The processor calculates the various position and orientation adjustments to be made in step 1532 and commands the gripper to reposition the lens 230 in step 1534. The processor measures the illumination profile in step 1536 and compares the profile parameter to a profile limit in step 1538.

If the profile parameter is within the profile limit, the process advances to step 1540 which repeats the process of step 1520. Otherwise, the process branches to step 1530. In step 1542, the new actual pointing direction is compared to the pointing limit. If the deviation of the new actual pointing direction from the expected pointing direction is still within the pointing limit, the process is completed and the LiDAR unit 110 is removed from the test apparatus 400 and sent to the next manufacturing station to bond the lens 230 in the final position. Otherwise, the process returns to step 1524.

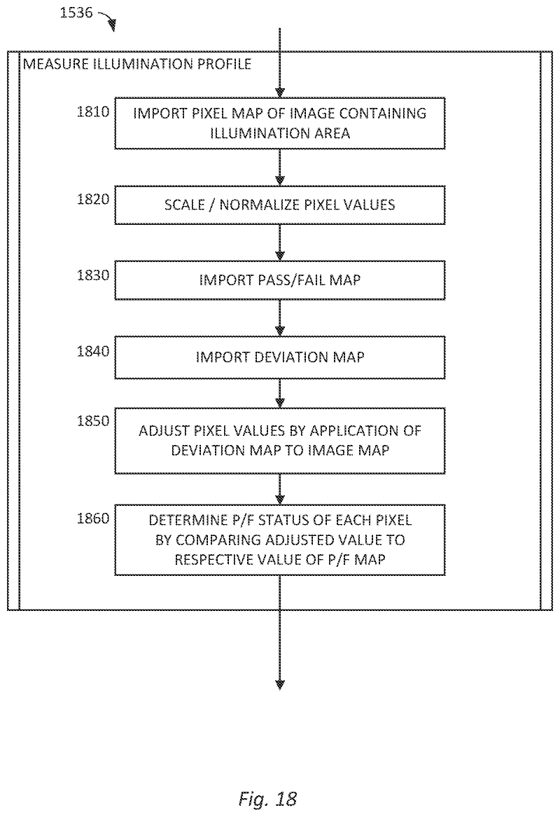

FIGS. 16-18 are example flowcharts of subprocesses of the flowchart of FIG. 15, according to certain aspects of the disclosed technology. FIG. 16 depicts the sub-process within step 1520. In step 1610, the processor commands the screen to move to the nominal position and commands the LiDAR unit to project an illumination beam that creates an illumination area on the screen. In step 1612, the imaging device captures a “nominal image” of the illumination area. Step 1620 moves the screen to the negative position and step 1622 captures a “negative image” of the illumination area. Step 1630 moves the screen to the positive position and step 1622 captures a “positive image” of the illumination area.

Step 1640 determines the lateral offset of the negative and positive images from the nominal image, as described with reference to FIG. 8. Step 1642 plots the cross-correlation values and step 1644 determines the slope of the best-fit curve as described with reference to FIG. 9. Step 1646 determines the actual pointing direction of the LiDAR unit and the deviation from the expected pointing angle.

FIG. 17 depicts the sub-process within step 1530. In step 1710, the processor plots the cumulative curve for a single ROI as described with respect to FIG. 11. Step 1720 calculates the derivative of the cumulative curve and plots the slope curve as described with respect to FIG. 12. Step 1730 performs an FFT on the slope curve and plots the FFT curve as described with respect to FIG. 13. Step 1740 determines a value of the FFT curve in one or more windows. Step 1750 determines the shift in the cumulative curve between pairs of the images of an ROI at the nominal, negative, and positive screen positions as described with respect to FIG. 14. Step 1760 calculates a single SFT value of the respective ROI.

FIG. 18 depicts the sub-process within step 1536. In step 1810, the processor imports a pixel map of the image of the entire illumination area. In certain embodiments, the image is stitched together from multiple images that each capture a portion of the illumination area. Step 1820 scales the pixel map to normalize it against the scaling of the pass/fail map and deviation maps. In certain embodiments, the scaling compensates for the actual duration of exposure of the image. In certain embodiments, each pixel value is respectively multiplied by a fixed scaling factor. In certain embodiments, each pixel value is respectively multiplied by a variable scaling factor selected such that the maximum pixel value of the pixel map is adjusted to a predetermined value. Step 1830 imports a pixel-by-pixel pass/fail (P/F) map. In certain embodiments, the threshold value of each pixel in the P/F map may be different. Step 1840 imports a deviation map wherein each pixel has a scale factor that compensates for known variations in the illumination related to the optical design. Step 1850 adjusts each individual pixel value by applying the respective deviation value from the deviation map to the scaled value of the pixel. Step 1860 compares the adjusted value of each pixel to the P/F threshold of the respective pixel of the P/F map.

In certain embodiments, the decision step 1542 determines the number of pixels that fail the comparison of step 1860 and compare the number of failed pixels to a threshold and branches to step 1524 if the number of failed pixels is greater than the threshold. In certain embodiments, step 1542 calculates the percentage of pixels that fail and compares the failed percentage to a threshold.

In summary, the disclosed systems and methods describe an adaptive alignment system that uses an iterative approach to adjust the internal optics of a LiDAR device so that the actual pointing direction and characteristics of the projected illumination area are within predetermined limits, compared to the expected pointing direction and expected shape of the illumination area. The process defines regions of interest that provide information that is used to separately determine the required adjustments in four degrees of freedom of the optics position and orientation to achieve the shape and focus of the projected illumination area. As part of the disclosed system, a test apparatus is disclosed that provides the structure and equipment to capture images of the projected illumination areas at various locations that, when analyzed as described herein, provide the information otherwise not available in conventional testing to determine the pointing direction of a projected illumination beam.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus for testing a Light Detection And Ranging (LiDAR) unit having a base and a transmission lens and configured to project an illumination beam, comprising:
a bottom frame configured to accept the LiDAR unit;
a screen movably coupled to the bottom frame, the screen having at least two positions; and
an imaging device coupled to the bottom frame and configured to observe the screen in the at least two positions.

2. The apparatus of claim 1, wherein:
the screen and bottom frame are arranged such that the illumination beam projected by an accepted LiDAR unit creates an illumination area onto the screen in each of the at least two positions;
the screen is movable along an expected pointing direction of the accepted LiDAR unit;
the at least two positions of the screen are each disposed along the expected pointing direction at a different distance from the bottom frame; and
the imaging device is arranged to observe the entire illumination area in each of the at least two positions of the screen.

3. The apparatus of claim 2, wherein:
an image provided by the imaging device of the entire illumination area has a first resolution; and
the imaging device is configured to selectively observe a portion of the illumination area at a second resolution that is higher than the first resolution.

4. The apparatus of claim 2, wherein:
the screen comprises a translucent layer;
the screen and bottom frame are arranged such that the accepted LiDAR unit projects an illumination beam that creates the illumination area on the translucent layer; and
the imaging device is arranged to observe the translucent layer.

5. The apparatus of claim 1, further comprising:
an actuator coupled between the bottom frame and the screen and configured to move the screen between the at least two positions.

6. The apparatus of claim 1, further comprising:
a gripper coupled to the bottom frame and configured to adjust at least one of a position and an orientation of the transmission lens with respect to the base.

7. A system for automatically aligning a Light Detection And Ranging (LiDAR) unit having a base and a transmission lens and configured to project an illumination beam, comprising:
a test apparatus comprising:
a bottom frame configured to accept the LiDAR unit;
a screen movable along an expected pointing direction of the accepted LiDAR unit, the screen having at least two positions each at a different distance from the bottom frame;
an actuator coupled between the bottom frame and the screen and configured to move the screen between the at least two positions;
an imaging device coupled to the bottom frame and configured to observe the screen in the at least two positions; and
a processor communicatively coupled to the imaging device and the actuator; and
a non-volatile memory communicatively coupled to the processor and containing instructions that, when loaded into the processor and executed, cause the processor to execute steps:
receiving a first image of the projected illumination area from the image device while the screen is disposed at a first position of the at least two positions;
receiving a second image of the projected illumination area from the imaging device while the screen is disposed at a second position of the at least two positions;
determining an offset of the second image from the first image; and
calculating an actual pointing direction of the accepted LiDAR unit based in part on the determined offset.

8. The system of claim 7, wherein the step of determining the offset comprises:
performing a correlation of the second image with the first image;
identifying a location in one of the first and second images of a maximum correlation value; and
calculating the offset based in part on the identified location.

9. The system of claim 7, wherein:
the test apparatus further comprises a gripper coupled to the bottom frame and configured to adjust at least one of a position and an orientation of the transmission lens with respect to the base;
the processor is communicatively coupled to the gripper;
the memory further comprises instructions that cause the processor to execute steps:
determining whether the actual pointing direction is within a predetermined acceptable range relative to the expected pointing direction; and
causing the gripper to adjust, if the actual pointing direction is outside of the acceptable range, at least one of the position and the orientation of the transmission lens.

10. The system of claim 7, wherein the memory further comprises instructions that cause the processor to execute steps:
receiving an image of a first region-of-interest (ROI) and an image of a second ROI that is displaced from the first ROI, wherein:
the screen and bottom frame are arranged such that the illumination beam projected by an accepted LiDAR unit creates an illumination area onto the screen in each of the at least two positions; and
each ROI is a portion of the illumination area;
determining an intensity of each pixel of the received images of the first and second ROIs;
plotting a curve of a cumulative number of pixels in the image of the first ROI having an intensity less than equal to a threshold value vs the threshold and a curve of a cumulative number of pixels in the image of the second ROI having an intensity less than equal to a threshold value vs the threshold;
plotting a slope of the cumulative curve of the first ROI and a slope of the cumulative curve of the second ROI;
transforming the slope curve of the first ROI into a frequency domain curve and the slope curve of the second ROI into a frequency domain curve;
identifying a value of the frequency domain curve of the first ROI at a first predetermined frequency and a value of the frequency domain curve of the second ROI at a second predetermined frequency; and
determining a first degree-of-freedom (DOF) parameter by calculating a difference between the value of the first ROI and the value of the second ROI.

11. The system of claim 10, wherein:
the illumination area comprises an X-axis and a Y-axis perpendicular to the X-axis;
the second ROI is displaced from the first ROI along the Y-axis;
the second ROI is not displaced from the first ROI along the X-axis; and
the first DOF parameter is associated with a rotational orientation of the transmission lens about a lens axis that corresponds to the X-axis of the illumination area.

12. The system of claim 11, wherein the memory further comprises instructions that cause the processor to execute steps:
receiving an image of a third ROI that is displaced from the first ROI along the X-axis;
plotting a curve of a cumulative number of pixels in the image of the third ROI having an intensity less than equal to a threshold value vs the threshold;
plotting a slope of the cumulative curve of the third ROI;
transforming the slope curve of the third ROI into a frequency domain curve;
identifying a value of the frequency domain curve of the third ROI at a third predetermined frequency; and
determining a second DOF parameter by calculating a difference between the value of first ROI and the value of the third ROI;
wherein the second DOF parameter is associated with a rotational orientation of the transmission lens about a lens axis that corresponds to the Y-axis of the illumination area.

13. The system of claim 12, wherein the memory further comprises instructions that cause the processor to execute steps:
receiving an image of a fourth ROI that is displaced from the second ROI along the X-axis;
plotting a curve of a cumulative number of pixels in the image of the fourth ROI having an intensity less than equal to a threshold value vs the threshold;
plotting a slope of the cumulative curve of the fourth ROI;
transforming the slope curve of the fourth ROI into a frequency domain curve;
identifying a value of the frequency domain curve of the fourth ROI at a fourth predetermined frequency; and
determining a third DOF parameter by calculating a third difference between a first difference between the value of first ROI and the value of the third ROI and a second difference between the value of second ROI and the value of the fourth ROI;
wherein the third DOF parameter is associated with a rotational orientation of the transmission lens about a lens axis that corresponds to a Z-axis of the illumination area that is perpendicular to both the X-axis and Y-axis.

14. A non-volatile, computer-readable medium containing instructions that, when loaded into a processor and executed, cause the processor to execute steps for automatically aligning a Light Detection And Ranging (LiDAR) unit having a base and a transmission lens and configured to project an illumination beam, the instructions comprising steps:
receiving from an imaging device a first image of an illumination area projected by the LiDAR unit on a screen disposed at a first position;
receiving from the imaging device a second image of the illumination area projected by the LiDAR unit on the screen disposed at a second position;
determining an offset of the second image from the first image; and
calculating an actual pointing direction of the accepted LiDAR unit based in part of the determined offset.

15. The medium of claim 14, wherein the step of determining the offset comprises:
performing a correlation of the second image with the first image;
identifying a location in one of the first and second images of a maximum correlation value; and
calculating the offset based in part of the identified location.

16. The medium of claim 14, wherein the medium further contains instructions that cause the processor to execute steps:
determining whether the actual pointing direction is within a predetermined acceptable range relative to the expected pointing direction; and
causing a gripper to adjust, if the actual pointing direction is outside of the acceptable range, at least one of a position and an orientation of the transmission lens with respect to the base.

17. The medium of claim 14, wherein the medium further comprises instructions that cause the processor to execute steps:
receiving from an imaging device an image of a first region-of-interest (ROI) and an image of a second ROI that is displaced from the first ROI;
determining an intensity of each pixel of the received images of the first and second ROIs;
plotting a curve of a cumulative number of pixels in the image of the first ROI having an intensity less than equal to a threshold value vs the threshold and a curve of a cumulative number of pixels in the image of the second ROI having an intensity less than equal to a threshold value vs the threshold;
plotting a slope of the cumulative curve of the first ROI and a slope of the cumulative curve of the second ROI;
transforming the slope curve of the first ROI into a frequency domain curve and the slope curve of the second ROI into a frequency domain curve;
identifying a value of the frequency domain curve of the first ROI at a first predetermined frequency and a value of the frequency domain curve of the second ROI at a second predetermined frequency; and
determining a first degree-of-freedom (DOF) parameter by calculating a difference between the value of the first ROI and the value of the second ROI.

18. The medium of claim 17, wherein:
the illumination area comprises an X-axis and a Y-axis perpendicular to the X-axis;
the second ROI is displaced from the first ROI along the Y-axis;
the second ROI is not displaced from the first ROI along the X-axis; and
the first DOF parameter is associated with a rotational orientation of the transmission lens about an axis that corresponds to the X-axis of the illumination area.

19. The medium of claim 18, wherein the medium further comprises instructions that cause the processor to execute steps:
receiving from an imaging device an image of a third ROI that is displaced from the first ROI along the X-axis;
plotting a curve of a cumulative number of pixels in the image of the third ROI having an intensity less than equal to a threshold value vs the threshold;
plotting a slope of the cumulative curve of the third ROI;
transforming the slope curve of the third ROI into a frequency domain curve;
identifying a value of the frequency domain curve of the third ROI at a third predetermined frequency; and
determining a second DOF parameter by calculating a difference between the value of first ROI and the value of the third ROI;
wherein the second DOF parameter is associated with a rotational orientation of the transmission lens about an axis that corresponds to the Y-axis of the illumination area.

20. The medium of claim 19, wherein the medium further comprises instructions that cause the processor to execute steps:
receiving from an imaging device an image of a fourth ROI that is displaced from the second ROI along the X-axis;
plotting a curve of a cumulative number of pixels in the image of the fourth ROI having an intensity less than equal to a threshold value vs the threshold;
plotting a slope of the cumulative curve of the fourth ROI;
transforming the slope curve of the fourth ROI into a frequency domain curve;
identifying a value of the frequency domain curve of the fourth ROI at a fourth predetermined frequency; and
determining a third DOF parameter by calculating a third difference between a first difference between the value of first ROI and the value of the third ROI and a second difference between the value of second ROI and the value of the fourth ROI;
wherein the third DOF parameter is associated with a rotational orientation of the transmission lens about an axis that corresponds to a Z-axis of the illumination area that is perpendicular to both the X-axis and Y-axis.
